(19) United States
(12) Patent Application Publication
(10) Pub. No.: US 2023/0002196 A1
(43) Pub. Date: Jan. 5, 2023

(54) SAFETY SYSTEM FOR ELEVATOR, ELEVATOR SYSTEM AND SAFETY CONTROL METHOD

(71) Applicant: Otis Elevator Company, Farmington, CT (US)

(72) Inventor: Hongliang Tian, Shanghai (CN)

(21) Appl. No.: 17/535,012

(22) Filed: Nov. 24, 2021

(30) Foreign Application Priority Data
Jun. 30, 2021 (CN) 202110734775.1

(51) Int. Cl. B66B 13/22; B66B 1/34; B66B 1/30

(52) U.S. Cl. CPC B66B 13/22; B66B 1/3492; B66B 1/30

(57) ABSTRACT

An elevator safety system, an elevator system, and an elevator safety control method. The elevator safety system includes a plurality of elevator safety chain sections connected in series and assigned to individual floors of an elevator. Each of the elevator safety chain sections includes a hall door switch, an inter-floor limit switch, a hall door bypass switch and a limit bypass switch arranged in series, and a processing circuit for controlling on-off of the various switches. The safety system is configured to additionally conduct the elevator safety chain section of the current floor when the elevator hall door is in the abnormally opened state, and at the same time of trying to automatically release the passengers to be rescued, the stability of running or stopping the elevator system is ensured.

### FOREIGN PRIORITY

This application claims priority to Chinese Patent Application No. 202110734775.1, filed Jun. 30, 2021, and all the benefits accruing therefrom under 35 U.S.C. § 119, the contents of which in its entirety are herein incorporated by reference.

### TECHNICAL FIELD

The present application relates to the field of elevator safety; in particular, the present application relates an elevator safety chain configured to monitor a safety state of an elevator in a specific situation. More specifically, the present application relates to an elevator safety system, an elevator system, and an elevator safety control method.

### BACKGROUND

As a tool for improving the walking of passengers between floors or shortening a walking distance of passengers, passenger transportation devices are very common in daily life. As an example, the most common passenger transportation devices are escalators and elevators that are usually used between floors of commercial buildings, and moving walkways that are usually used in large airports.

An elevator system typically includes one or more elevator cars that can move along an elevator hoistway. The elevator hoistway is provided with openings for connecting elevator-waiting halls of individual floors respectively, and elevator hall doors are arranged at these openings accordingly. When the elevator car runs to a corresponding floor, a car door and the hall door move in association so that the two are opened or closed simultaneously, thereby ensuring the safety of passengers during normal use of the elevator and in other situations.

In order to ensure the safety of the elevator system in the hall door, a switch device (such as a contact switch) is usually used to monitor its opening and closing state. For example, before and during the operation of the elevator car of the elevator system, it is necessary to ensure that the hall doors of all the floors remain closed and mechanically locked through the switch device, etc.

At present, there exists an elevator safety chain with a switch device, which ensures that the elevator is triggered to stop running when the hall door is not normally closed, so as to prevent passengers from being accidentally pinched. However, this safety triggering process is short and sudden. When the elevator system detects that the safety chain is cut off, it may control the elevator car to stop emergently, so that the passengers are trapped in the car for a long time while waiting for rescue. Each of the aforementioned situations will affect the passenger's experience in taking the elevator.

### SUMMARY

The present application aims to provide an elevator safety system, an elevator system, and an elevator safety control method to solve or at least alleviate at least some of the aforementioned technical problems.

In order to achieve at least one object of the present application, according to an aspect of the present application, an elevator safety system is provided, which includes a plurality of elevator safety chain sections connected in series and assigned to individual floors of an elevator, the elevator safety chain section including: a hall door switch, which is configured to detect an opening and closing state of a hall door of a current floor, and which is conducted when the hall door of the current floor is closed, and is opened when the hall door is opened; an inter-floor limit switch, which is configured to be opened in a controlled manner when a car is in a preset interval between the current floor and an adjacent floor, and which is conducted when the car is in other positions; a hall door bypass switch and a limit bypass switch arranged in series; and a processing circuit which is configured to: control the hall door bypass switch to be conducted and the limit bypass switch to be opened when the hall door switch is in an abnormally opened state, so that the elevator safety chain section can be conducted at the current floor via the hall door bypass switch and the inter-floor limit switch.

In addition to one or more of the above features, or as an alternative solution, in another embodiment, the processing circuit is further configured to: control the hall door bypass switch to be opened and the limit bypass switch to be conducted when the hall door switch is not in the abnormally opened state, so that the elevator safety chain section can at least be conducted at the current floor via the hall door switch and the limit bypass switch in sequence.

In addition to one or more of the above features, or as an alternative solution, in another embodiment, the safety system further includes: a top limit switch which is configured to be opened in a controlled manner when the car moves to be higher than a top floor by a first preset distance, and which is conducted when the car is in other positions; and/or a bottom limit switch which is configured to be opened in a controlled manner when the car moves to be lower than a bottom floor by a second preset distance, and which is conducted when the car is in other positions.

In addition to one or more of the above features, or as an alternative solution, in another embodiment, the limit bypass switch includes a first limit bypass switch and a second limit bypass switch arranged in series on both sides of the hall door bypass switch respectively, in which: in the elevator safety chain section of an intermediate floor, the second limit bypass switch of the current floor and the first limit bypass switch of a lower adjacent floor are respectively arranged in parallel with the inter-floor limit switch; or, the first limit bypass switch of the current floor and the second limit bypass switch of an upper adjacent floor are respectively arranged in parallel with the inter-floor limit switch; and/or in the elevator safety chain section of the top floor, the first limit bypass switch of the current floor is arranged in parallel with the top limit switch; and/or in the elevator safety chain section of the bottom floor, the second limit bypass switch of the current floor is arranged in parallel with the bottom limit switch.

In addition to one or more of the above features, or as an alternative solution, in another embodiment, the inter-floor limit switch is arranged in a hoistway at a middle position that is equidistant from the current floor and an adjacent floor; and/or the top limit switch is arranged in the hoistway at a third preset distance from the top floor; and/or the bottom limit switch is arranged in the hoistway at a fourth preset distance from the bottom floor.

In addition to one or more of the above features, or as an alternative solution, in another embodiment, the abnormally opened state of the hall door switch includes: the hall door switch has not received an opening instruction, and the hall door is in an open state.

In addition to one or more of the above features, or as an alternative solution, in another embodiment, the processing circuit is further configured to: receive an opening and closing state of the hall door switch and an on-off instruction for the hall door switch, judge whether the hall door switch is in the abnormally opened state based on the opening and closing state of the hall door switch and whether there is the on-off instruction for the hall door switch, and accordingly determine whether to issue a shielding instruction for the hall door switch; or the processing circuit is further configured to: receive and transmit an opening and closing state of the hall door switch, and receive a shielding instruction for the hall door switch when the hall door switch is in the abnormally opened state.

In addition to one or more of the above features, or as an alternative solution, in another embodiment, the safety system further includes optocoupler circuits assigned to individual floors of the elevator, and the processing circuit is further configured to receive the opening and closing states of the hall door switches collected by the optocoupler circuits.

In addition to one or more of the above features, or as an alternative solution, in another embodiment, the safety system further includes relays assigned to individual floors of the elevator, and the relays are controlled by the processing circuit to achieve on-off of the hall door bypass switch and the limit bypass switch.

In addition to one or more of the above features, or as an alternative solution, in another embodiment, the hall door switch and the hall door bypass switch are arranged in parallel in the elevator safety chain section; and/or the inter-floor limit switch and the limit bypass switch are arranged in parallel in the elevator safety chain section.

In addition to one or more of the above features, or as an alternative solution, in another embodiment, the hall door switch includes a plurality of switches arranged in series, and the plurality of switches respectively correspond to a plurality of hall doors of the current floor.

In addition to one or more of the above-mentioned features, or as an alternative solution, in another embodiment, the safety system further includes: an actuating component coupled to the car; in which when the car is in the preset interval between the current floor and the adjacent floor, the actuating component opens the inter-floor limit switch.

In addition to one or more of the above features, or as an alternative solution, in another embodiment, the actuating component includes an actuating push rod, and when the car is in the preset interval between the current floor and the adjacent floor, the actuating push rod opens the inter-floor limit switch by thrust; or the actuating component includes an actuating magnetic element, and when the car is in the preset interval between the current floor and the adjacent floor, the actuating magnetic element opens the inter-floor limit switch by magnetic force.

In addition to one or more of the above-mentioned features, or as an alternative solution, in another embodiment, the actuating push rod is arranged symmetrically in a vertical direction with respect to the car; or the actuating magnetic element is arranged symmetrically in the vertical direction with respect to the car.

In addition to one or more of the above features, or as an alternative solution, in another embodiment, the actuating push rod includes an upper push rod and a lower push rod that are arranged separately, and the upper push rod and the lower push rod are arranged symmetrically in the vertical direction with respect to the car; or the actuating magnetic element includes an upper magnetic element and a lower magnetic element that are arranged separately, and the upper magnetic element and the lower magnetic element are arranged symmetrically in the vertical direction with respect to the car.

In order to achieve at least one object of the present application, according to another aspect of the present application, an elevator system is provided, which includes: the elevator safety system as described above; and an elevator controller, which is communicatively coupled to the processing circuits assigned to individual floors of the elevator.

In addition to one or more of the above features, or as an alternative solution, in another embodiment, the elevator controller is configured to: receive the opening and closing state of the hall door switch transmitted by the processing circuit, judge whether the hall door switch is in the abnormally opened state based on the opening and closing state of the hall door switch and whether there is an on-off instruction for the hall door switch, and accordingly determine whether to transmit a shielding instruction for the hall door switch to the processing circuit; or the elevator controller is configured to transmit whether there is an on-off instruction for the hall door switch to the processing circuit; and the processing circuit is further configured to: receive the opening and closing state of the hall door switch and the on-off instruction for the hall door switch, judge whether the hall door switch is in the abnormally opened state based on the opening and closing state of the hall door switch and the on-off instruction for the hall door switch, and accordingly determine whether to issue a shielding instruction for the hall door switch.

In addition to one or more of the above-mentioned features, or as an alternative solution, in another embodiment, the elevator controller is further configured to control the car to run to the nearest floor to the car at a speed lower than a preset speed when the hall door switch is in the abnormally opened state, and control the hall door of the nearest floor to be opened.

In addition to one or more of the above features, or as an alternative solution, in another embodiment, the elevator controller is further configured to control the hall door of the current floor to be opened in a case where the hall door switch is in the abnormally opened state, the car is in the current floor and the elevator safety chain section is conducted.

In order to achieve at least one object of the present application, according to further another aspect of the present application, an elevator safety control method is also provided, which is used in the elevator system as described above, and the method includes: controlling the hall door bypass switch to be conducted and the limit bypass switch to be opened when the hall door switch is in the abnormally opened state, so that the elevator safety chain section can be conducted at the current floor via the hall door bypass switch and the inter-floor limit switch.

In addition to one or more of the above features, or as an alternative solution, in another embodiment, the control method further includes: controlling the hall door bypass switch to be opened and the limit bypass switch to be conducted when the hall door switch is not in the abnormally opened state, so that the elevator safety chain section can be conducted in the current floor at least via the hall door switch and the limit bypass switch in sequence.

In addition to one or more of the above features, or as an alternative solution, in another embodiment, when the elevator system comprises a top limit switch and/or a bottom limit switch, the method further includes: opening the top limit switch when the car moves to be higher than the top floor by a first preset distance, and conducting the top limit switch when the car is in other positions; and/or opening the bottom limit switch when the car moves to be lower than the bottom floor by a second preset distance, and conducting the bottom limit switch when the car is in other positions.

In addition to one or more of the above features, or as an alternative solution, in another embodiment, the control method further includes: when the hall door switch is in the abnormally opened state, controlling the car to run to the nearest floor to the car at a speed lower than a preset speed, and controlling the hall door of the nearest floor to be opened.

In addition to one or more of the above features, or as an alternative solution, in another embodiment, the control method further includes: when the hall door switch is in the abnormally opened state, the car is located on the current floor and the elevator safety chain section is conducted, controlling the hall door of the current floor to be opened.

In addition to one or more of the above features, or as an alternative solution, in another embodiment, the abnormally opened state of the hall door switch includes: the hall door switch has not received an opening instruction, and the hall door is in an open state.

According to the elevator safety system, elevator system, and elevator safety control method provided by the embodiments of the present application, when the hall door switch is in the abnormally opened state, that is, when the elevator hall door is not normally closed, the switches can be toggled to additionally conduct the elevator safety chain section of the current floor, and at the same time of trying to automatically release the passengers to be rescued, the stability of running or stopping the elevator system is ensured, that is, the elevator is prevented from stopping suddenly to a certain extent, and the panic of passengers is reduced. Further, elevator system can ensure the safety when the hall door switch is in the abnormally opened state and prevent the passenger from being nipped. In addition, only when the car runs to be close enough to the floor corresponding to the elevator hall door that is not normally closed until the inter-floor limit switch is triggered to be opened, the emergency stop method is used to ensure the safety of passengers so as to ensure that under whatever circumstance, the safety of passengers has a higher priority, and the passenger's experience and negative emotions will be improved as much as possible only their safety are guaranteed.

### BRIEF DESCRIPTION OF THE DRAWINGS

From the following detailed description in conjunction with the accompanying drawings, the above and other objects and advantages of the present application will become more complete and clearer, in which identical or similar elements are denoted by identical reference numerals.

FIG. 1 schematically shows an elevator system according to an embodiment of the present application, in which an elevator safety system of an embodiment of the present application is applied.

FIG. 2 schematically shows an elevator safety system according to another embodiment of the present application, in which thick solid lines show a conduction scheme of the elevator safety chain section when the hall door switch is not in an abnormally opened state.

FIG. 3 schematically shows an elevator safety system according to another embodiment of the present application, in which thick solid lines show a conduction scheme of the elevator safety chain section when the hall door switch is in the abnormally opened state.

FIG. 4 schematically shows an elevator safety system according to an embodiment of the present application, in which a working process of an actuating component is shown.

FIG. 5 schematically shows an actuating component of an elevator safety system according to an embodiment of the present application.

FIG. 6 schematically shows an actuating component of an elevator safety system according to another embodiment of the present application.

### DETAILED DESCRIPTION OF THE EMBODIMENT(S)

For brevity and illustrative purpose, herein, reference is mainly made to exemplary embodiments of the present application to describe the principles of the present application. However, those skilled in the art will readily recognize that the same principles can be equally applied to all types of elevator safety systems, elevator systems, and elevator safety control methods, in which the same or similar principles can be implemented. Any such changes do not depart from the true spirit and scope of the present application.

The current floor in this document refers to a certain floor of the elevator, which is the studied object, and each floor of the elevator can be studied as the current floor. That is, when a certain floor is the studied object, this floor will be temporarily referred to as the current floor.

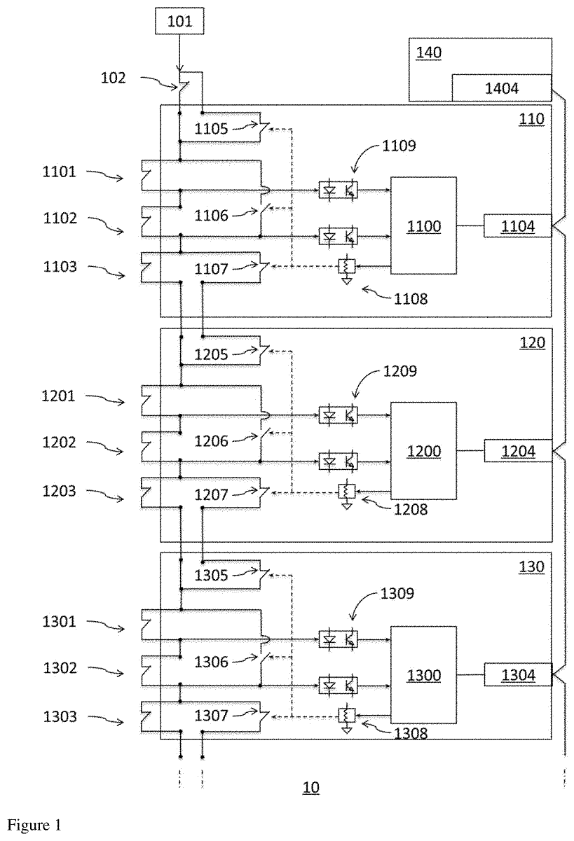

The present application provides an elevator safety system and an elevator system respectively. An embodiment of an elevator system with an elevator safety system 10 is shown in FIG. 1. The elevator safety system 10 includes a plurality of elevator safety chain sections connected in series and assigned to individual floors of the elevator, and all the elevator safety chain sections together form a complete elevator safety chain of the elevator safety system. The “plurality” of elevator safety chain sections mentioned herein usually refer to the number of elevator safety chain sections corresponding to the number of elevator floors; of course, without emphasizing the number of elevator floors, the “plurality” of elevator safety chain sections mentioned herein are two or more elevator safety chain sections. Specifically, on each floor of the elevator, each elevator safety chain section includes a hall door switch, an inter-floor limit switch, a processing circuit, and a normally open switch serving as the hall door bypass switch and a first normally closed switch and a second normally closed switch serving as the limit bypass switches, and the hall door bypass switch is arranged in series with the limit bypass switches. The elevator safety system 10 shown in FIG. 1 further includes a top limit switch 102 placed above a top floor of the elevator and a bottom limit switch (not shown) placed under a bottom floor of the elevator. In addition, FIG. 1 also shows a method for introducing a power source 101 for the elevator safety chain. For example, the power source 101 may be a 110V AV or a 30V DC, etc.

The top limit switch 102 may be opened in a controlled manner when the car moves to be higher than the top floor by a first preset distance, and remains closed when the car is in other positions so as to conduct a relevant branch. In this way, if the elevator continues to move upward by more than the first preset distance after arriving at the top floor, a closing mechanism of the top limit switch 102 will be cut off under force directly (contacting) or indirectly (non-contacting), thereby cutting off the elevator safety chain section so as to cut off the entire elevator safety chain. When the elevator safety chain cannot be conducted, an elevator controller 140 in the corresponding elevator system can control the elevator car to stop running, so as to prevent the elevator car from running out of the border or continuing to run when the hall door of the top floor is not completely closed, which would otherwise cause an accident.

Similarly, the bottom limit switch (not shown) can be opened in a controlled manner when the car moves to be lower than the bottom floor by a second preset distance, and remains closed when the car is in other positions so as to conduct a relevant branch. In this way, if the elevator continues to move downward by more than the second preset distance after arriving at the bottom floor, a closing mechanism of the bottom limit switch will be cut off under force directly (contacting) or indirectly (non-contacting), thereby cutting off the elevator safety chain section so as to cut off the entire elevator safety chain. When the elevator safety chain cannot be conducted, the elevator controller 140 in the corresponding elevator system can control the elevator car to stop running, so as to prevent the elevator car from running out of the border or continuing to run when the hall door of the bottom floor is not completely closed, which would otherwise cause an accident.

The top limit switch 102 and the bottom limit switch may have the same shape or configuration as inter-floor limit switches described below, and they are described separately herein only due to the uniqueness of their arrangement positions and functions. In addition, contact switches commonly used in the field may be chosen for all of the top limit switch 102, the bottom limit switch and various switches described below.

With continued reference to FIG. 1, as for a floor 110 (the top floor) in the figure, it has hall door switches 1101 and 1102, an inter-floor limit switch 1103, a processing circuit 1100, a normally open switch 1106 serving as a hall door bypass switch, as well as a first normally closed switch 1105 serving as a first limit bypass switch and a second normally closed switch 1107 serving as a second limit bypass switch; as for a floor 120 in the figure, it has hall door switches 1201 and 1202, an inter-floor limit switch 1203, a processing circuit 1200, a normally open switch 1206 serving as a hall door bypass switch, as well as a first normally closed switch 1205 serving as a first limit bypass switch and a second normally closed switches 1207 serving as a second limit bypass switch; and as for a floor 130 in the figure, it has hall door switches 1301 and 1302, an inter-floor limit switch 1303, a processing circuit 1300, a normally open switch 1306 serving as a hall door bypass switch, as well as a first normally closed switch 1305 serving as a first limit bypass switch and a second normally closed switches 1307 serving as a second limit bypass switch. Each floor (including the bottom floor) not shown in the figure may also have a configuration similar to those of the floors 110, 120 and 130, and a repeated description is omitted herein.

The floors 110, 120 and 130 shown in the figure each have two hall door switches connected in series, which correspond to hall doors provided on both sides respectively. This layout is commonly seen in hospitals, shopping malls and other places with a large flow of people. In some examples, when there is only one hall door on each floor, there may be only one hall door switch. In other examples, if necessary, the hall door switch may also include a plurality of (two or more) switches connected in series, and the plurality of switches correspond to the plurality of (two or more) hall doors on the current floor respectively. The purpose of the serial arrangement of the hall door switches is that if any one of the hall door switches fails to be closed, the elevator safety chain cannot be conducted on this branch.

In the following, the working principle of the elevator safety system according to some examples of the present disclosure will be explained by using the floor 120 as a representative example (as the current floor).

The hall door switches 1101 and 1102 of the floor 120, which serve as opening and closing detection sensors for the two hall doors of the floor 120, are configured to detect an opening and closing state of the two hall doors of the current floor; they are conducted when the hall doors of the current floor are closed, and they are opened when the hall doors are opened. In a case where contact switches are chosen for the hall door switches 1101 and 1102, when the hall door is closed (a distance between the two halves of the hall door is less than a certain value at this time, e.g., 1 cm), the contact of the hall door switch will touch another pole so that the hall door switch is in a closed state.

The inter-floor limit switch 1103 on an upper side of the floor 120 is opened in a controlled manner when the car is in a preset interval between the current floor and an upper adjacent floor, the inter-floor limit switch 1203 on a lower side of the floor 120 is opened in a controlled manner when the car is in a preset interval between the current floor and a lower adjacent floor, and the inter-floor limit switch 1103 and the inter-floor limit switch 1203 are conducted when the car is in other positions. Taking the preset interval between the current floor and the lower adjacent floor as an example, it may be formed between a position a preset distance below the floor 120 and a position a preset distance above the lower adjacent floor. For example, the preset distances for forming the aforementioned preset interval may be a certain distance value between 100 mm and 300 mm. The inter-floor limit switches 1103 and 1203 may force the two poles of their switch contacts to be out of contact when the inter-floor limit switches 1103 and 1203 are pressed by a mechanical actuating structure of a certain actuating component coupled to a car body, that is, the inter-floor limit switches 1103, 1203 are opened. Taking the inter-floor limit switch 1203 as an example, an action range of the actuating component ranges from a position a preset distance below the current floor (e.g., 100 mm) to a position a preset distance above the lower adjacent floor. It should be understood that the preset distances described in this document with the current floor or adjacent floor as the reference object are each measured by taking an alignment position of the car with the hall door of the current floor or the adjacent floor (for example, the middle position of the car coincides with the middle position of the hall door) as the reference. Other similar descriptions of positional relationships may be inferred based on this, and will not be described repeatedly; accordingly, positions of the preset intervals formed based on these preset distances can also be known. Such arrangements of the limit switches enable the corresponding inter-floor limit switch to be triggered after the car moves downward or upward by more than a preset distance from the current floor, so that the branch where the inter-floor limit switch in the elevator safety chain is located is opened. Similarly, when the car moves upward by more than the first preset distance from the top floor, the corresponding top limit switch will be triggered, so that the branch where the top limit switch in the elevator safety chain is located is opened. Similarly, when the car moves downward by more than the second preset distance from the bottom floor, the corresponding bottom limit switch will be triggered, so that the branch where the bottom limit switch in the elevator safety chain is located is opened.

The processing circuit 1200 of the floor 120 may be in the form of a micro-processing unit, a general-purpose processor, a dedicated processor, and the like. The processing circuit 1200 is configured to, when the hall door switch is not in an abnormally opened state, control the normally open switch 1206 serving as the hall door bypass switch to be opened, and control the first normally closed switch 1205 serving as the first limit bypass switch and the second normally closed switch 1207 serving as the second limit bypass switch to be closed, so that the elevator safety chain section can be conducted in the current floor at least via the first normally closed switch 1205, the hall door switches 1201 and 1202, and the second normally closed switch 1207 in sequence. The conduction of the elevator safety chain section in the current floor means that there is no situation where the elevator safety chain is interrupted in the current floor or the upper and lower floors (if any) are interrupted.

The processing circuit 1200 of the floor 120 is further configured to, when the hall door switch is in the abnormally opened state, control the normally open switch 1206 to be closed, and control the first normally closed switch 1205 and the second normally closed switch 1207 to be opened, so that the elevator safety chain section can be conducted in the current floor (the floor 120) via the normally open switch 1206 and the limit switch 1203.

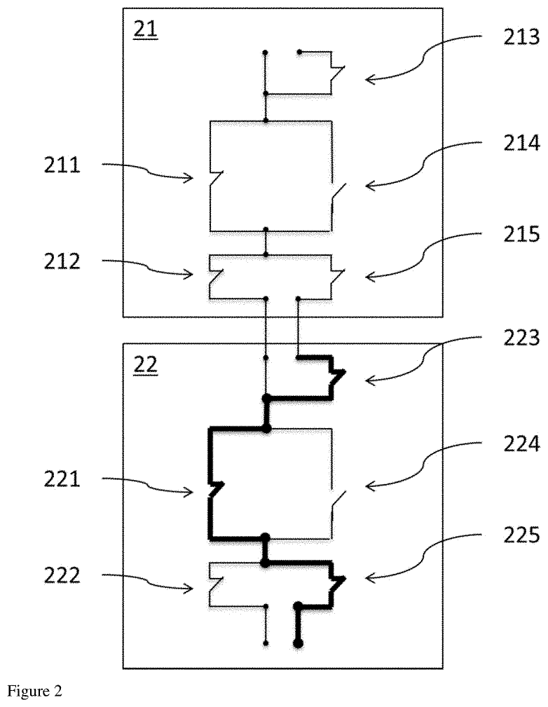

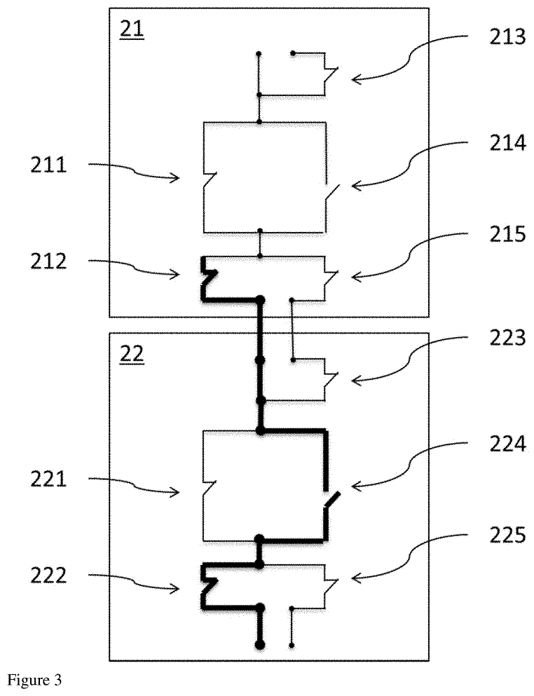

To simplify the discussion, reference is made to the critical elevator safety chain sections shown in FIGS. 2 and 3 as an example. For the purpose of clearly explaining the principle of the example of the present disclosure, several components such as processing circuits of various floors are omitted as compared with FIG. 1. As shown in the figures, a floor 21 includes a hall door switch 211, an inter-floor limit switch 212, a normally open switch 214 serving as the hall door bypass switch, as well as a first normally closed switch 213 serving as the first limit bypass switch and a second normally closed switch 215 serving as the second limit bypass switch; a floor 22 includes a hall door switch 221, an inter-floor limit switch 222, a normally open switch 224 serving as the hall door bypass switch, as well as a first normally closed switch 223 serving as the first limit bypass switch and a second normally closed switch 225 serving as the second limit bypass switch.

With reference to FIG. 2, the processing circuit of the floor 22 is configured to, when the hall door switch is not in the abnormally opened state, control the normally open switch 224 to be opened, and control the first normally closed switch 223 and the second normally closed switch 225 to be closed, so that the elevator safety chain section can be conducted in the current floor at least via the first normally closed switch 223, the hall door switch 221, and the second normally closed switch 225 in sequence. Thick lines in FIG. 2 show a path that enables the elevator safety chain section to be conducted in the current floor as described above. This configuration can ensure that a reliable path is established in the current floor for the elevator safety chain section when the hall door switch 221 is not shielded.

With reference to FIG. 3, the processing circuit of the floor 22 is further configured to, when the hall door switch is in the abnormally opened state, control the normally open switch 224 to be closed, and control the first normally closed switch 223 and the second normally closed switch 225 to be opened, so that the elevator safety chain section can be conducted in the current floor via the normally open switch 224 and the inter-floor limit switch 222. Thick lines in FIG. 3 show a path that enables the elevator safety chain section to be conducted in the current floor as described above. For the convenience of description, the figure also shows extension of the path to the upper adjacent floor (the floor 21). This configuration can ensure that when the hall door switch 221 is shielded, an adapted way to establish a path in the current floor for the elevator safety chain can also be provided. In a case where the inter-floor limit switches 212 and 222 remain closed, this adapted path can exist for a period of time.

It should be understood that “can be conducted” in this document means that this configuration creates the possibility for forming a corresponding conduction path, but if there are other interference factors (for example, switch failure, etc.), it is possible that this path is not actually formed.

In this document, “can at least be conducted” means that in addition to the above-mentioned possible paths, there may also be other paths that enable the elevator safety chain to be conducted in the current floor. For example, if the inter-floor limit switch 222 is not opened, the elevator safety chain section in FIG. 2 can also be conducted in the current floor via the first normally closed switch 223, the hall door switch 221, and the inter-floor limit switch 222 in sequence.

As can be known from the above description of the principle of the limit switch, the inter-floor limit switch 212 is opened under force when the car is in a preset interval (a first interval) from a position a preset distance below the floor 21 (e.g., when the car is in a descending state) to a position a preset distance above the floor 22 (e.g., when the car is in an ascending state). The inter-floor limit switch 222 is opened under force when the car is in a preset interval (a second interval) from a position a preset distance below the floor 22 (e.g., when the car is in a descending state) to a position a preset distance above the lower adjacent floor not shown (e.g., when the car is in an ascending state). The opening of any one of the inter-floor limit switches 212 and 222 will cause the adapted path to disappear, so that the elevator safety chain will be cut off and the elevator system will stop running.

In other words, when the car is not in the first interval or the second interval, the corresponding elevator safety chain section can exist for a period of time. Therefore, even if some of the hall door switches are shielded, the elevator system also can run for a period of time, such as at a reduced speed, and will not stop running suddenly. When the car is in the above first interval or the second interval, it means that the car is already extremely close to the hall door that is in the open state, and if the shielding of the hall door switch is caused by the failure of the hall door to close normally, then the continued running of the car in the first interval and the second interval may lead to pinching and injury to passengers who accidentally enter the hall door that fails to close normally. Therefore, according to the above configuration, if the car is in the above first interval or the second interval, the corresponding elevator safety chain section will be cut off, so that the entire elevator safety chain will be cut off and the elevator system will stop running.

In addition, the floor 22 includes two normally closed switches. When the hall door switch is in the abnormally opened state, theoretically, both the first normally closed switch 223 and the second normally closed switch 225 will be opened, but in actual situations, not both of them will be opened due to various unexpected factors. The purpose of setting two normally closed switches is that even if only one of the normally closed switches can be normally opened, the path passing through the two at the same time will be removed. This configuration can avoid the failure to cut off the elevator safety chain due to unexpected factors.

Returning to FIG. 1, the processing circuits 1100, 1200 and 1300 may be connected to a CAN interface 1404 of the elevator controller 140 of the elevator system through CAN interfaces 1104, 1204 and 1304 respectively, so as to realize communication with the elevator controller 140.

In the following, an interaction and control process between the processing circuits of the elevator safety system and the elevator controller of the elevator system according to some examples of the present disclosure will be explained by using the floor 120 as a representative example (as the current floor).

In some embodiments of the present application, indicators used to express the abnormally opened state of the hall door switch include: the hall door switch has not received an opening instruction, and the hall door is in the open state. For example, when the hall door switches 1201 and 1202 are in the open state and this is not caused by normal opening of the hall door, the elevator controller 140 or the processing circuit 1200 can judge that the hall doors corresponding to the hall door switches 1201 and 1202 cannot be closed normally, that is, the hall door switches 1201 and 1202 are in the abnormally opened state.

In the process of judging the abnormally opened state of the hall door switch, the processing circuit can either be used as a parameter collection device, or as a parameter processing device, or as both a parameter collection device and a parameter processing device. Correspondingly, the elevator controller can be used as an element complementary to the above processing circuits to realize the parameter collection function, or the parameter processing function, or both the parameter collection function and the parameter processing function for the remaining part.

As an example, referring to FIG. 1, the processing circuit 1200 is further configured to receive opening and closing states of the hall door switches 1201 and 1202 and an on-off instruction for the hall door switches 1201 and 1202, judge whether the hall door switches 1201 and 1202 are in the abnormally opened state based on the opening and closing states of the hall door switches 1201 and 1202 and whether there is the on-off instruction for the hall door switches 1201 and 1202, and accordingly determine whether to issue a shielding instruction for the hall door switches 1201 and 1202, so that the elevator safety chain has the characteristics described above. At this time, the processing circuit serves as the parameter processing device, and the elevator controller 140 only needs to be configured to transmit to the processing circuit whether there is an on-off instruction for the hall door switches 1201 and 1202.

As another example, the processing circuit 1200 is further configured to receive and transmit the opening and closing states of the hall door switches 1201 and 1202, and receive the shielding instruction for the hall door switches when the hall door switches 1201 and 1202 are in the abnormally opened state. At this time, the processing circuit only serves as a parameter transmission device and an instruction receiving device, and the elevator controller 140 is configured to receive the opening and closing states of the hall door switches 1201 and 1202 transmitted by the processing circuit 1200, judge whether the hall door switches 1201 and 1202 are in the abnormally opened state based on the opening and closing states of the hall door switches 1201 and 1202 and whether there is an on-off instruction for the hall door switches 1201 and 1202, and accordingly determine whether to transmit the shielding instruction for the hall door switches 1201 and 1202 to the processing circuit 1200, so that the elevator safety chain has the characteristics described above.

Referring to FIG. 1, taking the floor 120 as an example, in some embodiments of the present application, the hall door switches 1201, 1202 and the normally open switch 1206 are arranged in parallel in the elevator safety chain. Secondly, the inter-floor limit switch 1203 is also arranged in parallel with the second normally closed switch 1207 of the current floor and the first normally closed switch 1305 of the lower adjacent floor in the elevator safety chain. Furthermore, the inter-floor limit switch 1103 is also arranged in parallel with the first normally closed switch 1205 of the current floor and the second normally closed switch 1107 of the upper adjacent floor in the elevator safety chain. This type of parallel arrangement allows the elevator safety chain to be conducted when the branch on one side is conducted.

In some embodiments of the present application, when the processing circuit 1200 needs to collect the states of the hall door switches 1201 and 1202, optocoupler circuits 1109, 1209 and 1309 assigned to individual floors of the elevator can be provided for them, and the processing circuit is further configured to collect the states of the hall door switches through the optocoupler circuits. For example, FIG. 1 shows that the state of the hall door switch 1101 is collected by the optocoupler circuit 1109, the state of the hall door switch 1201 is collected by the optocoupler circuit 1209, and the state of the hall door switch 1301 is collected by the optocoupler circuit 1309. The introduction of the optocoupler circuit can avoid the crosstalk of the circuits on both sides of the optocoupler circuit. The other optocoupler circuits shown in the figure also have similar arrangements and effects.

In some still other embodiments of the present application, the elevator safety system 10 further includes forcibly guided relays 1108, 1208 and 1308, etc., which are assigned to individual floors of the elevator, and which are controlled by corresponding processing circuits to achieve on-off control of the corresponding normally open switch, the first normally closed switch and the second normally closed switch. That is, one relay will control three switches at the same time, which reduces the hardware cost and also reduces the complexity of the design.

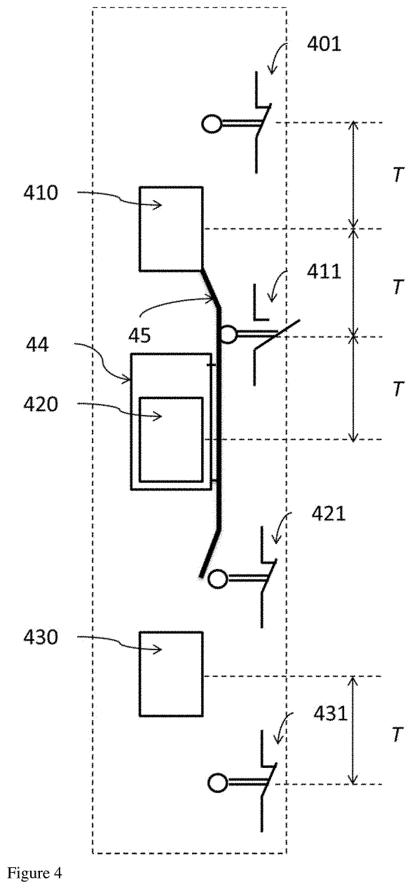

In some yet other embodiments of the present application, the inter-floor limit switches are all arranged in the hoistway at the middle positions that are equidistant from the current floor and adjacent floors, whereas the top limit switch is arranged in the hoistway at a third preset distance from the top floor, and the bottom limit switch is arranged in the hoistway at a fourth preset distance from the bottom floor. Referring to FIG. 4, an elevator system including three floors is schematically shown. Floors 410, 420, and 430 respectively have corresponding floor doors. A top limit switch 401 is arranged at a position at a distance T away from the top floor (the floor 410). An inter-floor limit switch 411 of the lower adjacent floor of the floor 410 is at a distance T from both the floor 410 and the floor 420. Similarly, an inter-floor limit switch 421 of the lower adjacent floor of the floor 420 is also at a distance T from both the floor 420 and the floor 430. In addition, the distance from a bottom limit switch 431 of the bottom floor (the floor 430) to the bottom floor 430 is also T. The above even arrangement will make calibration of the car position more reasonable. For example, the first interval and the second interval described above will be symmetrical with respect to the current floor.

As shown in FIG. 4, in some embodiments of the present application, the inter-floor limit switch 411 is squeezed and opened by an actuating push rod 45 coupled to a car 44. It should be noted that the coupling form in the figure is schematic, and the form of the actuating push rod 45 is also schematic. According to the principle of the present disclosure, other coupling forms and other structural forms of actuating components can be designed. For example, although not shown in the figure, the actuating component can also be configured as an actuating magnetic element. When the car is in a preset interval between the current floor and the adjacent floor, the actuating magnetic element can open the inter-floor limit switch through a magnetic force. Each of these actuating components has different advantages and can be selected according to the actual application situation. For example, mechanical actuating components have better stability; and magnetic actuating components will have lower friction due to their non-contact characteristics, and thus are more suitable for high-speed elevator application scenes.

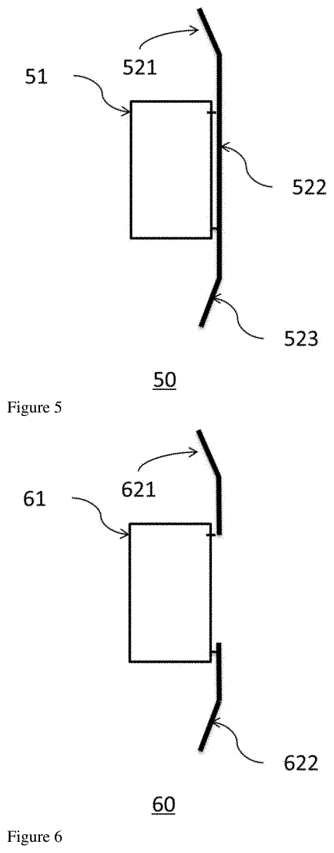

The specific structure and working process will be described in the following by taking the actuating push rod as an example. FIG. 4 is simplified in FIGS. 5 and 6. As shown in FIG. 5, in some embodiments of the present application, the actuating push rod is symmetrical in the vertical direction with respect to the car. Specifically, in an elevator system 50, the actuating push rod coupled to a car 51 in the illustrated manner includes three parts: an upper section 521, a middle section 522, and a lower section 523. These three parts form an entirety, in which the middle section 522 is axisymmetric, and the upper section 521 and the lower section 523 are designed as mirror images.

As shown in FIG. 6, in some other examples, the actuating push rod has an upper push rod and a lower push rod respectively coupled to the car, and the upper push rod and the lower push rod are symmetrical in the vertical direction with respect to the car. Specifically, in an elevator system 60, the actuating push rod coupled to a car 61 in the illustrated manner includes two parts: an upper section 621 and a lower section 622, in which the upper section 621 and the lower section 622 are designed as mirror images. The design shown in FIG. 6 can save material compared to the corresponding example in FIG. 5.

Similarly, the actuating magnetic elements not shown are also symmetrical in the vertical direction with respect to the car. Further, they can also adopt an integrated or separate structural arrangement, and thus have corresponding technical effects, which will not be repeated herein.

According to another aspect of the present application, an elevator system is also provided, which includes any of the elevator safety systems as described above and an elevator controller communicatively coupled with its processing circuit. The elevator system can prevent emergency stop of the elevator to a certain extent when the elevator hall door is not normally closed, thereby reducing the sense of panic of passengers. In addition, it can also ensure the safety of the elevator system when the elevator hall door is not normally closed, and prevent the car from pinching passengers.

In the following, functions and effects that the elevator controller in the elevator system can achieve in the elevator safety control process will be explained.

For example, in some embodiments of the present application, the elevator controller 140 is further configured to control the car to run at a speed lower than a preset speed (for example, 0.3 m/s) to the nearest floor to the car, when the hall door switch is in the abnormally opened state. For example, when it is found that the hall door switch of a certain floor is in the abnormally opened state, it may indicate that the corresponding hall door cannot be closed normally. At this time, the running of the car in the hoistway is at risk. In this case, the car can move to the nearest floor to the car at a speed lower than a normal running speed (for example, 0.5 m/s). When there are two floors close to the car at the same time, the floor in the original running direction of the car can be considered preferentially. In some examples, when the car runs to the nearest floor, the elevator controller 140 may also issue an instruction to open the hall door of the nearest floor, so as to facilitate the evacuation of the trapped person from the car.

In some embodiments of the present application, the elevator controller is further configured to determine whether to issue an instruction to open the hall door of the current floor when the hall door switch is in the abnormally opened state. For example, if the car is still in the low-speed running state described above, the hall door that cannot be normally closed on the current floor should not be opened. If the car is located on the current floor and the hall door of the current floor cannot be normally closed, then the hall door of the current floor can be opened to allow the trapped persons to evacuate from the car. Specifically, for example, in some embodiments of the present application, the elevator controller 140 is further configured to send an instruction to open the hall door of the current floor when the hall door switch is in the abnormally opened state, the car is on the current floor, and the safety chain is conducted. In this case, the car has not yet left the current floor, and the trapped persons can be evacuated from the car by opening the hall door.

Another aspect of the present application provides an elevator safety control method (hereinafter referred to as control method), which can be used in the elevator system in any of the foregoing embodiments or combinations thereof, and which therefore also has corresponding technical effects. Specifically, the elevator safety control method includes the following steps: controlling the hall door bypass switch to be closed and the limit bypass switch to be opened when the hall door switch is in the abnormally opened state, so that the elevator safety chain section can be conducted in the current floor via the hall door bypass switch and the inter-floor limit switch. For example, thick lines in FIG. 3 show a path that enables the elevator safety chain to be conducted in the current floor as described above. For the convenience of description, the figure also shows extension of the path to the upper adjacent floor (the floor 21). This configuration can ensure that when the hall door switch 221 is shielded, an adapted way to establish a path in the current floor for the elevator safety chain can also be provided. In a case where the limit switches 212 and 222 remain closed, this adapted path can exist for a period of time.

The control method may further include the following steps: controlling the hall door bypass switch to be opened and the limit bypass switch to be closed when the hall door switch is not in the abnormally opened state, so that the elevator safety chain section can be conducted in the current floor at least via the hall door switch and the limit bypass switch in sequence. For example, thick lines in FIG. 2 show a path that enables the elevator safety chain to be conducted in the current floor as described above. This configuration can ensure that a reliable path is established in the current floor for the elevator safety chain when the hall door switch 221 is not shielded.

In some examples, the elevator safety chain is also provided with a top limit switch and a bottom limit switch. At this time, the following control steps may be further added: opening the top limit switch when the car moves to be higher than the top floor by a first preset distance, and closing the top limit switch when the car is in other positions. By configuring the top limit switch in this way, if the elevator continues to move upward by more than the first preset distance after arriving at the top floor, the closing mechanism of the top limit switch will be cut off under force, thereby cutting off the elevator safety chain. When the elevator safety chain cannot be conducted, the elevator controller in the elevator safety system can control the car to stop running, so as to prevent the car from running out of the border or continuing to run when the hall door of the top floor is not completely closed, which would otherwise cause an accident. Similarly, the bottom limit switch can also be opened when the car moves to be lower than the bottom floor by a second preset distance, and the bottom limit switch can be closed when the car is in other positions. By configuring the bottom limit switch in this way, if the elevator continues to move downward by more than the second preset distance after arriving at the bottom floor, the closing mechanism of the bottom limit switch will be cut off under force, thereby cutting off the elevator safety chain. When the elevator safety chain cannot be conducted, the elevator controller in the elevator safety system can control the car to stop running, so as to prevent the car from running out of the border or continuing to run when the hall door of the top floor is not completely closed, which would otherwise cause an accident.

In some other examples, the method further includes: when the hall door switch is in the abnormally opened state, controlling the car to run to the nearest floor to the car at a speed lower than a preset speed, and controlling the hall door of the nearest floor to be opened, which reduces the discomfort of the trapped person in emergency stop and help them evacuate from the car as soon as possible.

In some still other examples, the method further includes: when the hall door switch is in the abnormally opened state, the car is located on the current floor and the elevator safety chain section is conducted, determining that the car has not yet left the current floor; therefore, the hall door of the current floor can be controlled to be opened, which helps the trapped person evacuate from the car as soon as possible.

The above elevator safety control method can prevent emergency stop of the elevator to a certain extent when the elevator hall door is not normally closed, thereby reducing the sense of panic of passengers. In addition, it can also ensure the safety of the elevator system when the elevator hall door is not normally closed, and prevent the car from pinching passengers.

Described above are only specific embodiments of the present application, but the scope of protection of the present application is not limited thereto. Those skilled in the art can think of other feasible changes or substitutions according to the technical scope disclosed in the present application, and these changes or substitutions are all covered by the scope of protection of the present application. The embodiments of the application and the features in the embodiments can also be combined with each other if there are no conflicts with each other. The scope of protection of the present application is subject to what is recorded in the claims.

What is claimed is:

1. An elevator safety system, comprising a plurality of elevator safety chain sections connected in series and assigned to individual floors of an elevator, the elevator safety chain section comprising:
a hall door switch, which is configured to detect an opening and closing state of a hall door of a current floor, and which is conducted when the hall door of the current floor is closed, and is opened when the hall door is opened;
an inter-floor limit switch, which is configured to be opened in a controlled manner when a car is in a preset interval between the current floor and an adjacent floor, and which is conducted when the car is in other positions;
a hall door bypass switch and a limit bypass switch arranged in series; and
a processing circuit which is configured to: control the hall door bypass switch to be conducted and the limit bypass switch to be opened when the hall door switch is in an abnormally opened state, so that the elevator safety chain section can be conducted at the current floor via the hall door bypass switch and the inter-floor limit switch.

2. The elevator safety system according to claim 1, wherein the processing circuit is further configured to: control the hall door bypass switch to be opened and the limit bypass switch to be conducted when the hall door switch is not in the abnormally opened state, so that the elevator safety chain section can at least be conducted at the current floor via the hall door switch and the limit bypass switch in sequence.

3. The elevator safety system according to claim 1, further comprising:
a top limit switch which is configured to be opened in a controlled manner when the car moves to be higher than a top floor by a first preset distance, and which is conducted when the car is in other positions; and/or
a bottom limit switch which is configured to be opened in a controlled manner when the car moves to be lower than a bottom floor by a second preset distance, and which is conducted when the car is in other positions.

4. The elevator safety system according to claim 3, wherein the limit bypass switch comprises a first limit bypass switch and a second limit bypass switch arranged in series on both sides of the hall door bypass switch respectively, wherein:
in the elevator safety chain section of an intermediate floor, the second limit bypass switch of the current floor and the first limit bypass switch of a lower adjacent floor are respectively arranged in parallel with the inter-floor limit switch; or, the first limit bypass switch of the current floor and the second limit bypass switch of an upper adjacent floor are respectively arranged in parallel with the inter-floor limit switch;
and/or in the elevator safety chain section of the top floor, the first limit bypass switch of the current floor is arranged in parallel with the top limit switch; and/or
in the elevator safety chain section of the bottom floor, the second limit bypass switch of the current floor is arranged in parallel with the bottom limit switch.

5. The elevator safety system according to claim 3, wherein:
the inter-floor limit switch is arranged in a hoistway at a middle position that is equidistant from the current floor and an adjacent floor; and/or
the top limit switch is arranged in the hoistway at a third preset distance from the top floor; and/or
the bottom limit switch is arranged in the hoistway at a fourth preset distance from the bottom floor.

6. The elevator safety system according to claim 1, wherein the abnormally opened state of the hall door switch comprises: the hall door switch has not received an opening instruction, and the hall door is in an open state.

7. The elevator safety system according to claim 6, wherein:
the processing circuit is further configured to: receive an opening and closing state of the hall door switch and an on-off instruction for the hall door switch, judge whether the hall door switch is in the abnormally opened state based on the opening and closing state of the hall door switch and whether there is the on-off instruction for the hall door switch, and accordingly determine whether to issue a shielding instruction for the hall door switch; or
the processing circuit is further configured to: receive and transmit an opening and closing state of the hall door switch, and receive a shielding instruction for the hall door switch when the hall door switch is in the abnormally opened state.

8. The elevator safety system according to claim 7, further comprising optocoupler circuits assigned to individual floors of the elevator, and the processing circuit is further configured to receive the opening and closing states of the hall door switches collected by the optocoupler circuits.

9. The elevator safety system according to claim 1, further comprising relays assigned to individual floors of the elevator, and the relays are controlled by the processing circuit to achieve on-off of the hall door bypass switch and the limit bypass switch.

10. The elevator safety system according to claim 1, wherein:
the hall door switch and the hall door bypass switch are arranged in parallel in the elevator safety chain section; and/or
the inter-floor limit switch and the limit bypass switch are arranged in parallel in the elevator safety chain section.

11. The elevator safety system according to claim 1, wherein the hall door switch comprises a plurality of switches arranged in series, and the plurality of switches respectively correspond to a plurality of hall doors of the current floor.

12. The elevator safety system according to claim 1, further comprising an actuating component coupled to the car; wherein when the car is in the preset interval between the current floor and the adjacent floor, the actuating component opens the inter-floor limit switch.

13. The elevator safety system according to claim 12, wherein:
the actuating component comprises an actuating push rod, and when the car is in the preset interval between the current floor and the adjacent floor, the actuating push rod opens the inter-floor limit switch by thrust; or
the actuating component comprises an actuating magnetic element, and when the car is in the preset interval between the current floor and the adjacent floor, the actuating magnetic element opens the inter-floor limit switch by magnetic force.

14. The elevator safety system according to claim 13, wherein:
the actuating push rod is arranged symmetrically in a vertical direction with respect to the car; or
the actuating magnetic element is arranged symmetrically in the vertical direction with respect to the car.

15. The elevator safety system according to claim 14, wherein:
the actuating push rod comprises an upper push rod and a lower push rod that are arranged separately, and the upper push rod and the lower push rod are arranged symmetrically in the vertical direction with respect to the car; or
the actuating magnetic element comprises an upper magnetic element and a lower magnetic element that are arranged separately, and the upper magnetic element and the lower magnetic element are arranged symmetrically in the vertical direction with respect to the car.

16. An elevator system, comprising: the elevator safety system according to claim 1; and an elevator controller, which is communicatively coupled to the processing circuits assigned to individual floors of the elevator.

17. The elevator system according to claim 16, wherein:
the elevator controller is configured to: receive the opening and closing state of the hall door switch transmitted by the processing circuit, judge whether the hall door switch is in the abnormally opened state based on the opening and closing state of the hall door switch and whether there is an on-off instruction for the hall door switch, and accordingly determine whether to transmit a shielding instruction for the hall door switch to the processing circuit; or
the elevator controller is configured to transmit whether there is an on-off instruction for the hall door switch to the processing circuit; and the processing circuit is further configured to: receive the opening and closing state of the hall door switch and the on-off instruction for the hall door switch, judge whether the hall door switch is in the abnormally opened state based on the opening and closing state of the hall door switch and the on-off instruction for the hall door switch, and accordingly determine whether to issue a shielding instruction for the hall door switch.

18. The elevator system according to claim 16, wherein the elevator controller is further configured to control the car to run to the nearest floor to the car at a speed lower than a preset speed when the hall door switch is in the abnormally opened state, and control the hall door of the nearest floor to be opened.

19. The elevator system according to claim 16, wherein the elevator controller is further configured to control the hall door of the current floor to be opened in a case where the hall door switch is in the abnormally opened state, the car is in the current floor and the elevator safety chain section is conducted.

20. An elevator safety control method, which is used in the elevator system according to claim 16, the method comprising:
controlling the hall door bypass switch to be conducted and the limit bypass switch to be opened when the hall door switch is in the abnormally opened state, so that the elevator safety chain section can be conducted at the current floor via the hall door bypass switch and the inter-floor limit switch.

21. The control method according to claim 20, further comprising:
controlling the hall door bypass switch to be opened and the limit bypass switch to be conducted when the hall door switch is not in the abnormally opened state, so that the elevator safety chain section can be conducted in the current floor at least via the hall door switch and the limit bypass switch in sequence.

22. The control method according to claim 20, wherein when the elevator system comprises a top limit switch and/or a bottom limit switch, the method further comprises:
opening the top limit switch when the car moves to be higher than the top floor by a first preset distance, and conducting the top limit switch when the car is in other positions; and/or
opening the bottom limit switch when the car moves to be lower than the bottom floor by a second preset distance, and conducting the bottom limit switch when the car is in other positions.

23. The control method according to claim 20, further comprising:
when the hall door switch is in the abnormally opened state, controlling the car to run to the nearest floor to the car at a speed lower than a preset speed, and controlling the hall door of the nearest floor to be opened.

24. The control method according to claim 20, further comprising:
when the hall door switch is in the abnormally opened state, the car is located on the current floor and the elevator safety chain section is conducted, controlling the hall door of the current floor to be opened.

25. The control method according to claim 20, wherein the abnormally opened state of the hall door switch comprises: the hall door switch has not received an opening instruction, and the hall door is in an open state.
